(19) United States
(12) Patent Application Publication
(10) Pub. No.: US 2019/0179588 A1
(43) Pub. Date: Jun. 13, 2019

(54) MOBILE TERMINAL DISPLAY OPTIONS FOR VEHICLE TELLTALES

(71) Applicant: QUALCOMM Incorporated, San Diego, CA (US)

(72) Inventors: Jeffrey Hao Chu, San Diego, CA (US); Rahul Gulati, San Diego, CA (US); Behnam Katibian, Irvine, CA (US); Alex Jong, San Diego, CA (US); Robert Hardacker, Fallbrook, CA (US); Reza Kakoee, San Diego, CA (US)

(21) Appl. No.: 16/275,441

(22) Filed: Feb. 14, 2019

Related U.S. Application Data
(63) Continuation-in-part of application No. 16/127,504, filed on Sep. 11, 2018.
(60) Provisional application No. 62/571,572, filed on Oct. 12, 2017.

(51) Int. Cl. G06F 3/14; G09G 5/00; G08B 21/18; G08B 3/10; H04L 12/40

(52) U.S. Cl. CPC G06F 3/1423; G09G 5/006; G08B 21/185; G08B 3/1016; H04L 2012/40273; G09G 2370/16; G09G 2330/12; G09G 2380/10; H04L 2012/40215; H04L 12/40195

(57) ABSTRACT

Alternative display options for vehicle telltales are disclosed. In one aspect, a fault condition in a telltale is detected, and the telltale is presented through a secondary display system in the vehicle, potentially bypassing any local control unit for the secondary display system. For example, a video telltale may be presented on an infotainment display after detection of a fault in the original telltale. By presenting the telltale in an alternate display, the operator remains informed of sensor conditions in the automobile and may take remedial action to fix the fault as well as any conditions which trigger a telltale.

### PRIORITY CLAIM

The present application is a continuation-in-part of U.S. patent application Ser. No. 16/127,504, filed on Sep. 11, 2018 and entitled “ALTERNATIVE DISPLAY OPTIONS FOR VEHICLE TELLTALES,” the contents of which is incorporated herein by reference in its entirety.

The '504 application claims priority to U.S. Provisional Patent Application Ser. No. 62/571,572 filed on Oct. 12, 2017 and entitled “ALTERNATIVE DISPLAY OPTIONS FOR VEHICLE TELLTALES,” the contents of which is incorporated herein by reference in its entirety.

### BACKGROUND

### I. Field of the Disclosure

The technology of the disclosure relates generally to displays in vehicles.

### II. Background

Current generations of automobiles rely heavily on computers and sensors to evaluate the general “health” and operation of the automobile. While sensors and gauges have existed in automobiles for many years allowing operators to know fuel levels, speed, engine temperature, battery level, and the like, the days of analog gauges are fading, and now such information is digitized and presented to an operator through a display. The display may be a simple backlit image or a video capable display or some combination of the two. Sensors may register faults or conditions and store data related to such faults or conditions in a memory device. Concurrently, information related to the fault or condition may be presented to the operator through the use of a telltale. Typically such telltales are provided on a display in the dashboard, where the display is in line with the steering wheel so that an operator may readily perceive the telltale. The operator may act on the telltale after recognizing the condition. In some instances, the memory device may be accessed through a diagnostic device to receive further information about the condition which triggered the telltale.

Currently, telltales have a failsafe operation profile. That is, the sensors are made as robust as possible to operate in any reasonably expected environmental or driving conditions, and the communication links are protected from such as well. Despite these precautions, failures do occur. Such failures may be as simple as a blown fuse, a burnt out light bulb, or the like. However, such failures may also be related to the communication link, the display, the sensor, or other point of failure. Currently, when such a failure occurs, the operator may be unaware of the failure, and more importantly, may be unaware of any condition which would otherwise be reported through such a failed telltale. The parent disclosure introduced the concept of using alternate displays to provide telltales to operators, but there remains room to explore various ways that mobile terminals may be used to provide telltales to operators. Accordingly, there may be opportunities to improve the ability to present telltales to operators.

### SUMMARY OF THE DISCLOSURE

Aspects disclosed in the detailed description include mobile terminal display options for vehicle telltales. In an exemplary aspect, a fault condition in a telltale is detected, and the telltale is presented through a secondary display system in the vehicle, where the secondary display system is a mobile terminal within the vehicle. The mobile terminal may be wirelessly connected to a vehicle control system or may be connected through a wire-based connector. By presenting the telltale on a mobile terminal display, the operator remains informed of sensor conditions in the automobile and may take remedial action to fix the fault condition as well as any conditions which trigger a telltale.

In this regard in one aspect, a method for controlling displays in a vehicle is disclosed. The method includes sending data from a first controller to a cluster display embedded control unit (ECU) of a vehicle for display on a cluster display within the cluster display ECU. The method also includes detecting a fault associated with the cluster display ECU of the vehicle or a communication path from the first controller to the cluster display ECU. The method also includes sending, from the first controller, cluster display information including at least one telltale to a secondary display on a mobile terminal in the vehicle.

In another aspect, an ECU is disclosed. The ECU includes a vehicle network interface configured to be coupled to a vehicle network. The ECU also includes a first cable interface configured to be coupled to a first cable. The ECU also includes a wireless connectivity module. The ECU also includes a control system including a system on a chip (SoC). The control system is configured to detect a fault in a cluster display ECU through the first cable. The control system is also configured to route cluster display information including a telltale to a mobile terminal through the wireless connectivity module.

In another aspect, an ECU is disclosed. The ECU includes a vehicle network interface configured to be coupled to a vehicle network. The ECU also includes a first cable interface configured to be coupled to a first cable. The ECU also includes a modem. The ECU also includes a control system including a system on a chip (SoC). The control system is configured to detect a fault in a cluster display ECU through the first cable. The control system is also configured to route cluster display information including a telltale to a mobile terminal through the modem.

In another aspect, an automobile is disclosed. The automobile includes a cluster display ECU. The cluster display ECU includes a cluster display. The cluster display ECU also includes a cluster microcontroller unit (MCU). The cluster display ECU also includes a first cable input configured to receive a first cable. The automobile also includes a control system ECU including a control MCU configured to detect a fault in the cluster display ECU and route telltale information to a mobile terminal.

### BRIEF DESCRIPTION OF THE FIGURES

FIG. 1A is a front elevational view of an exemplary dashboard having a plurality of displays;

FIG. 1B is a simplified top down view of a vehicle interior where the vehicle has multiple displays and may be coupled to a mobile terminal;

FIG. 2 is a front elevational view of a display having a plurality of exemplary telltales illuminated thereon;

FIG. 3 is a block diagram of the plural displays of FIG. 1A with associated controllers within a vehicle according to a first exemplary aspect such that each display has a dedicated controller;

FIG. 4 is a block diagram of the plural displays of FIG. 1A with an associated controller within a vehicle according to a second exemplary aspect where the displays share the associated controller;

FIG. 5 is a flowchart illustrating an exemplary process for providing alternative display options for telltales according to the present disclosure;

FIG. 6 is a block diagram of a first possible alternative display option for the system of FIG. 3;

FIG. 7 is a block diagram of a second possible alternative display option for the system of FIG. 3;

FIG. 8 is a block diagram of a possible alternative display option for the system of FIG. 4;

FIG. 9 is a block diagram of another alternative display option for the system of FIG. 4;

FIG. 10 is a block diagram of a first wireless system for display of telltales on a mobile terminal where a vehicle control system uses a distinct wireless component;

FIG. 11 is a block diagram of an alternate wireless system for display of telltales on a mobile terminal where the vehicle control system includes a wireless component;

FIG. 12 is a block diagram of another alternate wireless system for display of telltales on a mobile terminal where the vehicle control system calls the mobile terminal through a cellular modem;

FIG. 13 is a block diagram of an alternate wireless system with a combined cluster and infotainment controller having the ability to display telltales both on an infotainment display and a mobile terminal simultaneously or sequentially;

FIG. 14 is a block diagram of an alternate wireless system with a combined cluster and infotainment controller where the combined controller includes a wireless component;

FIG. 15 is a block diagram of a wire-based system for display of telltales on a mobile terminal;

FIG. 16 is a flowchart showing an exemplary process for hierarchically selecting alternate displays for telltales; and

FIG. 17 is a simplified block diagram of a mobile terminal.

### DETAILED DESCRIPTION

With reference now to the drawing figures, several exemplary aspects of the present disclosure are described. The word “exemplary” is used herein to mean “serving as an example, instance, or illustration.” Any aspect described herein as “exemplary” is not necessarily to be construed as preferred or advantageous over other aspects.

Aspects disclosed in the detailed description include mobile terminal display options for vehicle telltales. In an exemplary aspect, a fault condition in a telltale is detected, and the telltale is presented through a secondary display system in the vehicle, where the secondary display system is a mobile terminal within the vehicle. The mobile terminal may be wirelessly connected to a vehicle control system or may be connected through a wire-based connector. By presenting the telltale on a mobile terminal display, the operator remains informed of sensor conditions in the automobile and may take remedial action to fix the fault condition as well as any conditions which trigger a telltale.

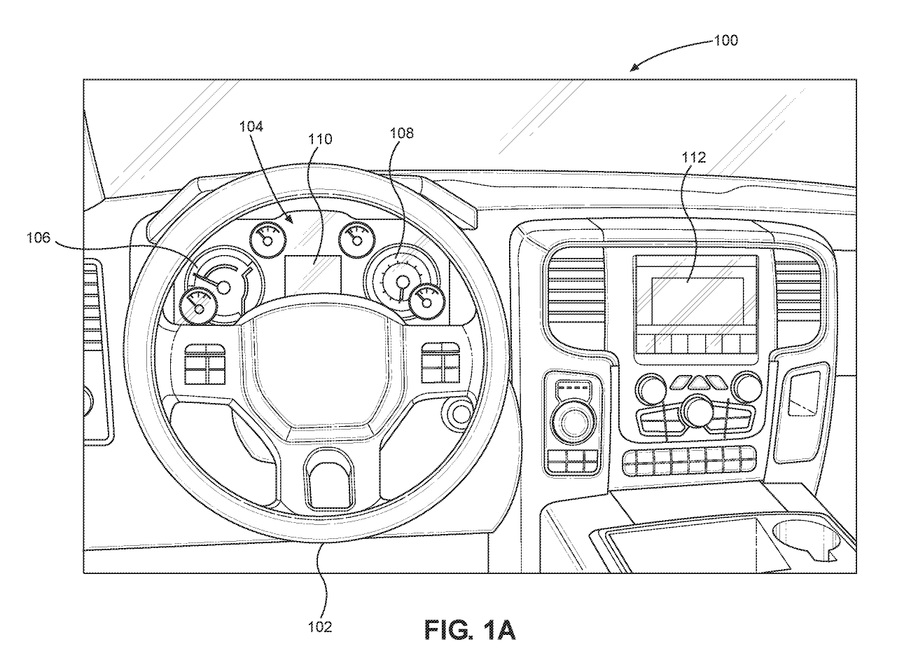

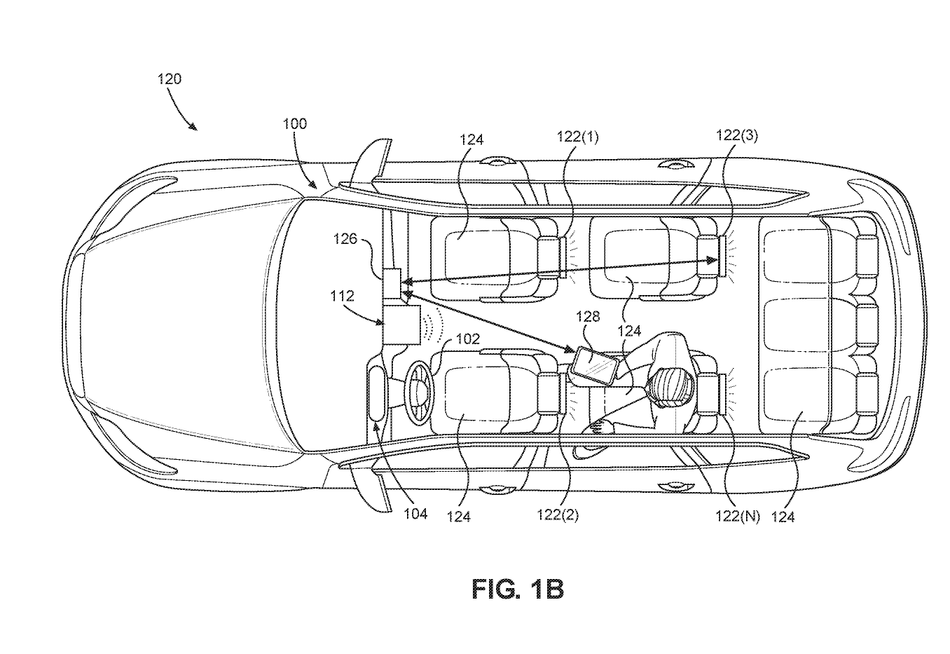

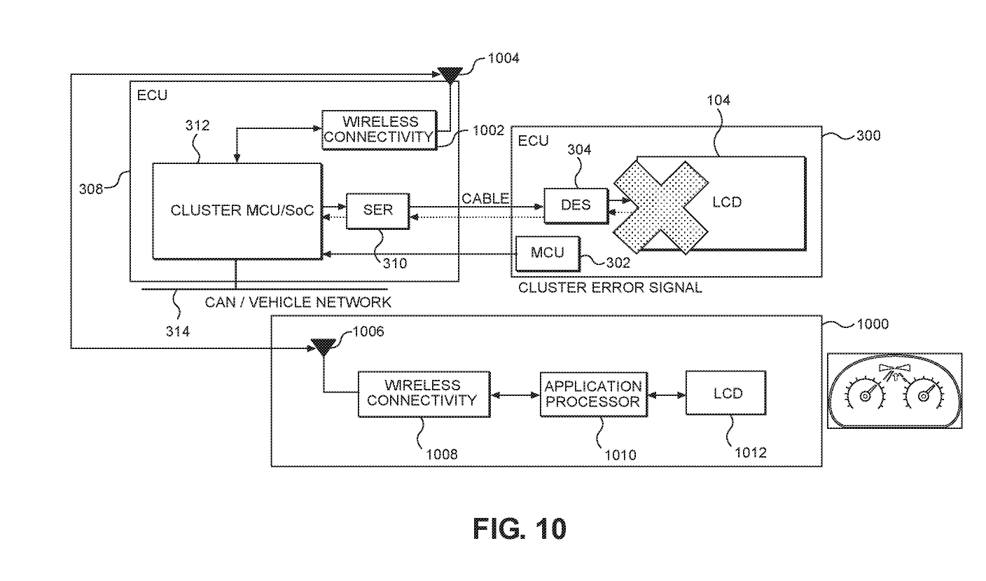

The discussion from the parent disclosure is provided with reference to FIGS. 1-9. A discussion of particular aspects of the present disclosure and various ways the vehicle may communicate with a mobile terminal begins below with reference to FIG. 10.

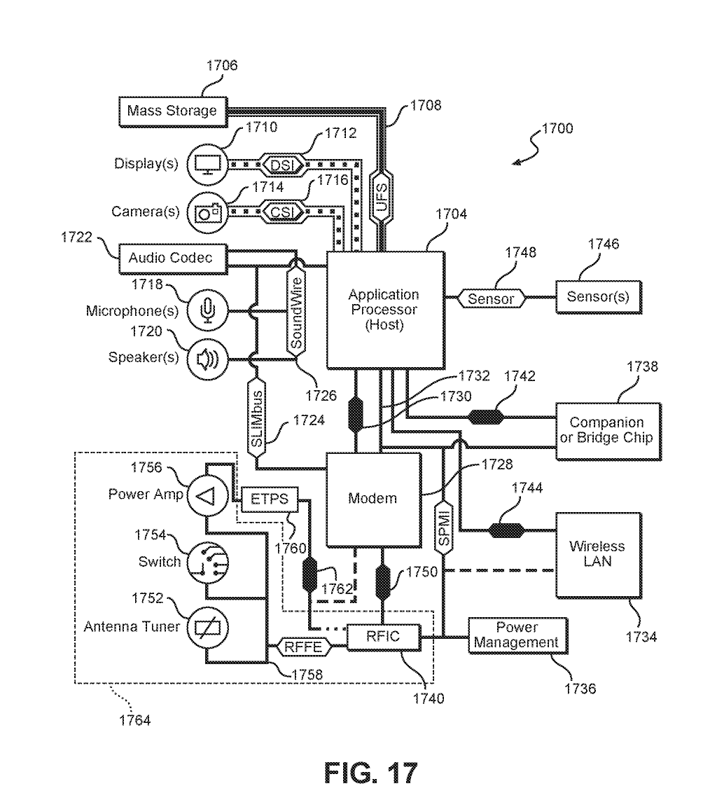

As used herein, a mobile terminal may be a cellular phone, a smartphone, a tablet, a phablet, a laptop computer, an entertainment unit, a navigation device, a communications device, a mobile location data unit, a global positioning system (GPS) device, a mobile phone, a portable computer, a mobile computing device, a wearable computing device (e.g., a smart watch, a health or fitness tracker, eyewear, etc.), a personal digital assistant (PDA), a radio, a satellite radio, a music player, a digital music player, a portable music player, a digital video player, a video player, a digital video disc (DVD) player, a portable digital video player, and the like. In relevant part, the mobile terminal needs to have the ability to receive signals and display telltales, and thus, a simplified block diagram of an exemplary mobile terminal is provided below with reference to FIG. 17.

While the present disclosure is presented with reference to an automobile, other vehicles such as boats, motorcycles, planes, and the like could benefit from the present disclosure and the particular environment is not limited to automobiles. However, for simplicity, the following discussion is provided with reference to an automobile.

In this regard, FIG. 1A is front elevational view of a dashboard 100 of a vehicle. The dashboard 100 includes a steering wheel 102. An instrument cluster display 104 is provided in the dashboard 100 in line with the steering wheel 102. The instrument cluster display 104 may be a liquid crystal display (LCD), a plasma display, or the like, and may include one or more additional analog display components or be broken into fields where different information is provided. For example, a tachometer 106 and a speedometer 108 may be positioned on either side of an LCD display 110. Additional displays such as a fuel gauge, an engine temperature gauge, a battery level gauge, and an oil pressure gauge or the like may be present. The dashboard 100 further includes a second display 112 that may be referred to as a console or infotainment display. The second display 112 may be an LCD, plasma display, touch screen, or the like. In normal use, the second display 112 may provide information about the radio station being played, any further information received from the radio station (e.g., artist name, song name), traffic information, navigation information, climate control information, phone call information if the vehicle is equipped with hands-free phone operations, and the like. Note that these functions may have duplicate control systems. Further, some controls may be present on the steering wheel 102.

It should be appreciated that many vehicles may have other displays and/or be connected to one or more mobile terminals. In this regard, a vehicle 120 is illustrated in FIG. 1B with the dashboard 100 having the displays 104 and 112 therein. Additional seat back displays 122(1)-122(N) may be present. As illustrated, N is four (4), but may be some other number as more or fewer seats 124 include displays. In some cases, the seat back displays 122(1)-122(N) may be hardwired into the audiovisual entertainment system of the vehicle 120. Alternatively, one or more of the seat back displays 122(1)-122(N) may be wirelessly coupled to the audiovisual entertainment system of the vehicle 120 such as through an antenna 126. Additionally, one or more mobile terminals 128 may be brought into the vehicle 120 and may couple to the audiovisual entertainment system of the vehicle 120. As illustrated, the coupling may be wireless through the antenna 126, but may also be through a cable connected to a plug outlet (e.g., a Universal Serial Bus (USB) port) (not illustrated).

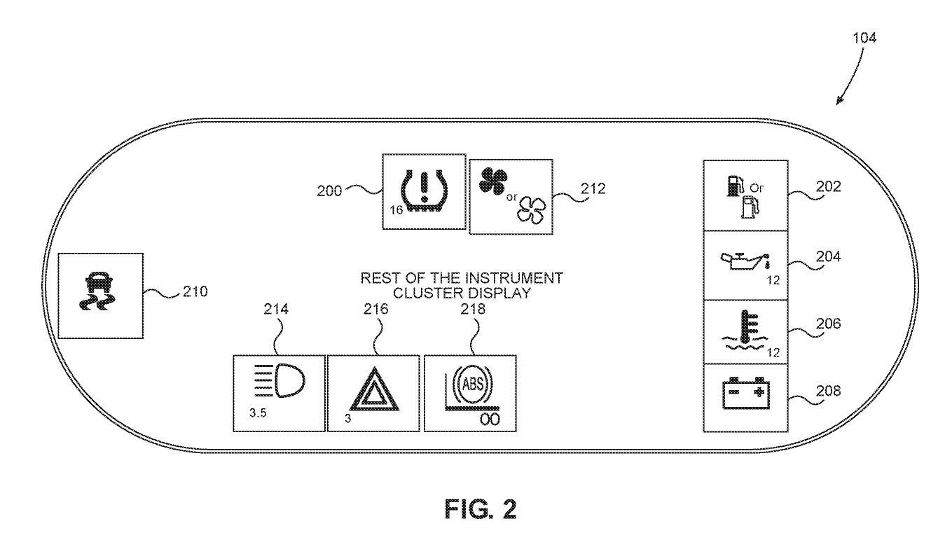

As used herein, a telltale is an indicator of a malfunction of a system within a motor vehicle by an illuminated symbol or text legend. Exemplary telltales are illustrated in the instrument cluster display 104 in FIG. 2. Specifically, FIG. 2 illustrates a low tire pressure telltale 200, a low fuel telltale 202, an oil pressure telltale 204, a temperature telltale 206, a battery level telltale 208, an electronic stability control telltale 210, a heating/air conditioning fan telltale 212, a bright headlight telltale 214, a hazard light telltale 216, and an antilock brake system telltale 218. It should be appreciated that other telltales may also be used and the present disclosure is not limited to just those listed here. Likewise, the precise placement of a telltale in the instrument cluster display 104 is not a central tenant of the present disclosure, and different automotive manufacturers may differently arrange the number, type, and placement of telltales.

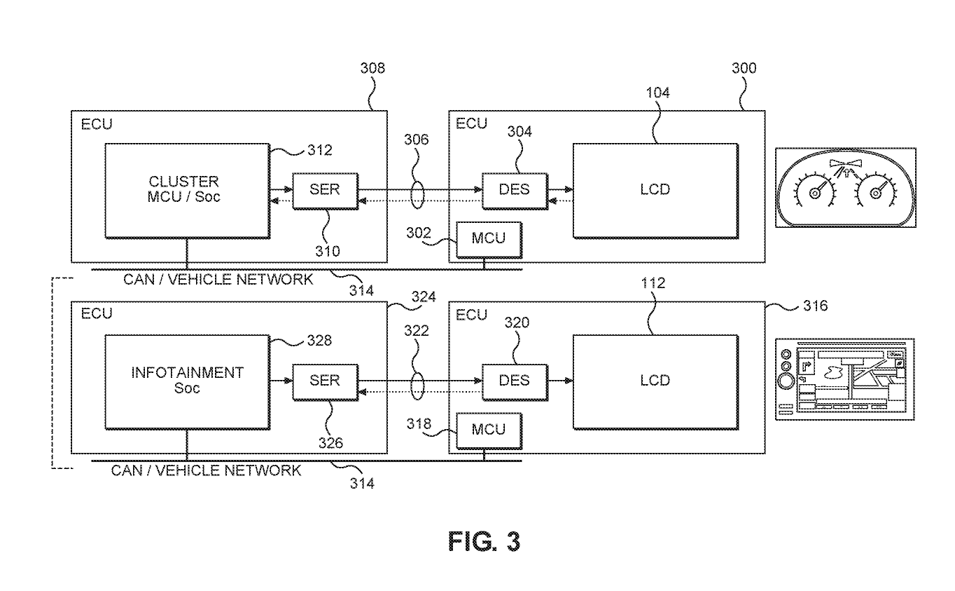

In normal operation, the instrument cluster display 104 is responsive to a local cluster microcontroller unit (MCU), and the second display 112 is responsive to a local infotainment system or second MCU. The local MCUs may communicate with a controller though a cable or through the vehicle network. This arrangement is illustrated with reference to FIG. 3. In particular, the instrument cluster display 104 may be positioned in an embedded control unit (ECU) 300. The ECU 300 includes an MCU 302 and a serializer/deserializer 304. Note that while illustrated as a single block, the serializer and deserializer components could be separate elements. The serializer/deserializer 304 primarily deserializes signals from a cable 306, wherein the signals consist of pixel data, horizontal and vertical timing control, and additional information, such as cyclic redundancy check (CRC) information, which will be sent to the instrument cluster display 104. The MCU 302 controls and monitors the components on the ECU 300. The MCU 302 may control tasks such as power up/down sequencing of the display or monitoring the functionality and operation of other components on the ECU 300. The MCU 302 may further be connected to a controller area network (CAN) 314 or other vehicle network. While current designs pass the pixel data/image frame in a raster scan format, the present disclosure is not so limited and telltale state information may be sent or the telltale may be sent in some other format that is processed so as to provide instructions to illuminate a telltale. The serializer/deserializer 304 may send backchannel or status information across the cable 306 to an ECU 308. While this backchannel information is normally serialized, it is possible that the data is already formatted as a single stream of data and the serializer may be omitted.

The ECU 308 may include a serializer/deserializer 310 and a cluster MCU 312. The cluster MCU 312 may sometimes be referred to as a system on a chip (SoC) or application processor (AP). The cluster MCU 312 may further communicate over the CAN 314 or other vehicle network. The serializer/deserializer 310 primarily serializes signals such as pixel data, horizontal and vertical timing control, and additional information, such as CRC information, for transmission over the cable 306 to the ECU 300, but may receive backchannel information from the ECU 300. Part of the backchannel information may include signals that act as a heartbeat signal that can be monitored by the cluster MCU 312 to indicate the data path to the instrument cluster display 104 is operational. Note that this data path includes the serializer/deserializer 310, the cable 306 connecting the ECU 308 and the ECU 300, the serializer/deserializer 304, and the instrument cluster display 104.

Note that the cable 306 may be a coaxial cable, a twisted pair, or the like and generally is configured to carry a differential signal and have sufficient bandwidth to carry video signals specifically. Note further that the CAN 314 may be a bi-directional communication bus and may sometimes be referred to herein as a vehicle network. Current CAN implementations are typically two-wire cables, but it should be appreciated that a vehicle network is not limited to such two-wire cables and the term vehicle network includes CANs, Ethernet-based networks, wireless networks, USB, Peripheral Component Interconnect (PCI) express (PCIE), Converged Input/Output (CIO), and the like with sufficient bandwidth to handle video signals.

With continued reference to FIG. 3, the second display 112 may be housed in its own ECU 316 which may have a display MCU 318 and a serializer/deserializer 320. The serializer/deserializer 320 primarily deserializes signals from a cable 322, wherein the signals consist of pixel data, horizontal and vertical timing control, and additional information, such as CRC information, which will be sent to the second display 112. The serializer/deserializer 320 may send backchannel or control information across the cable 322 to an ECU 324. The ECU 324 may include a serializer/deserializer 326 and an infotainment SoC 328. Note that the infotainment SoC 328 is also an MCU, although not labeled as such in the drawings. The infotainment SoC 328 may further communicate over the CAN 314. The serializer/deserializer 326 primarily serializes signals such as pixel data, horizontal and vertical timing control, and additional information, such as CRC information, for transmission over the cable 322 to the ECU 316, but may receive backchannel information from the ECU 316. Part of the backchannel information may include signals that act as a heartbeat signal that can be monitored by the infotainment SoC 328 to indicate the ECU 316 is operational. Alternatively, there may be a specific heartbeat signal, which may be implemented in a variety of ways without departing from the scope of the present disclosure. The cable 322 may be a coaxial cable, a twisted pair, or the like and generally is configured to carry a differential signal with sufficient bandwidth to convey a video signal.

In practice, the cluster MCU 312 receives reports from sensors about the health and operation of components of the vehicle such as tire pressure, oil pressure, fuel level, and the like. Based on these reports, the cluster MCU 312 may send the display image pixel data or other signal to the instrument cluster display 104 to update the status of one or more telltales on the instrument cluster display 104.

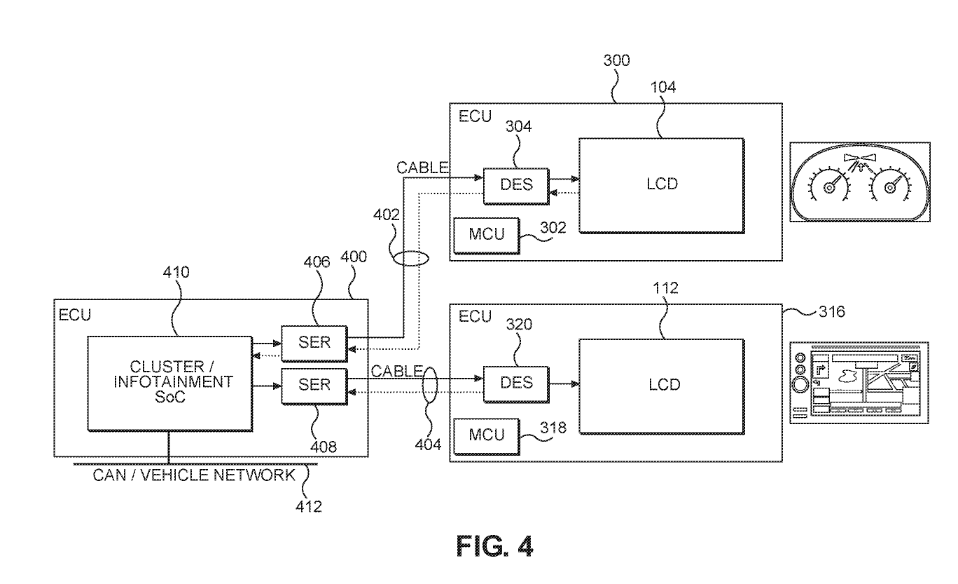

While FIG. 3 illustrates a system that has a separate controller for the instrument cluster display 104 and the second display 112, there are other configurations that may exist. For example, as illustrated in FIG. 4, a single controller may control the instrument cluster display 104 and the second display 112. In this regard, FIG. 4 illustrates a second arrangement where the ECU 300 and the ECU 316 both communicate with a single ECU 400 over a cable 402 and a cable 404, respectively. The ECU 400 includes two serializer/deserializers 406 and 408 for transmitting pixel data or other communication with the ECUs 300 and 316, respectively. The ECU 400 further includes a cluster/infotainment SoC 410. It should be appreciated that the cluster/infotainment SoC 410 is an MCU. The cluster/infotainment SoC 410 may also be coupled to a CAN 412 or other vehicle network to receive signals from sensors and the like.

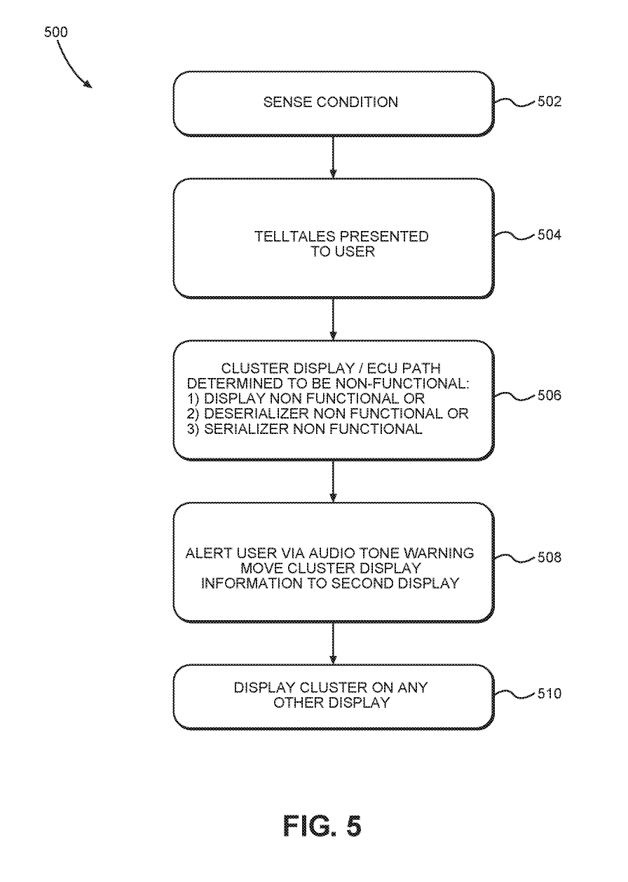

In normal operation, sensors associated with the vehicle monitor environmental and operational conditions and provide input to the cluster SoC 312 (or the cluster/infotainment SoC 410). If there is a telltale update, the cluster SoC 312 (or the cluster/infotainment SoC 410) sends the pixel data to be displayed to the instrument cluster display 104 or otherwise communicates with the MCU 302 to cause illumination of the telltale on the instrument cluster display 104. However, when a fault is present in the pixel data path (or general communication path) to the ECU 300, the instrument cluster display 104 is not updated with the correct telltale state to be observed by the driver/user. Exemplary aspects of the present disclosure recognize the fault in the path to the instrument cluster display 104 and cause the telltale status to be shown on the second display 112 or other secondary display such as the seat back displays 122(1)-122(N) and/or the mobile terminal 128. In some cases the pixel stream is duplicated for the second display 112, but it is also possible that instructions are sent which cause a telltale to appear on the second display 112. Additionally, or alternatively, an audible telltale is provided to the operator. This process is illustrated in FIG. 5, where process 500 is set forth. Note that this audible alert may be provided on detection of the fault or alternatively may be provided when the telltale is routed to the second display 112.

The process 500 begins with a condition being sensed (block 502) that triggers a telltale. For example, tire pressure may be low in one or more of the tires of the vehicle. In normal operation, the telltales are presented to the user (operator) (block 504). When the instrument cluster display 104 and/or the pixel data path to the instrument cluster display 104 is determined to be non-functional (e.g., as a result of the instrument cluster display 104 being non-functional, the serializer/deserializer 304 being non-functional, or the serializer/deserializer 310 being non-functional) (block 506), a warning, such as an audio tone, may be provided to indicate failure and cluster display information is moved to a secondary display, which may be the second display 112 (block 508), another display within the vehicle such as the backseat displays 122(1)-122(N), and/or the mobile terminal 128. Any of the secondary displays may duplicate the instrument cluster display 104 such that the telltales are presented on this secondary display (block 510). In an alternate aspect, the instrument cluster display 104 may be duplicated on multiple secondary displays. Note that the detection of the non-functionality may be effectuated by loss of the heartbeat signal, detection of corruption, detection of a blown fuse, a line fault error, or other mechanism as needed or desired.

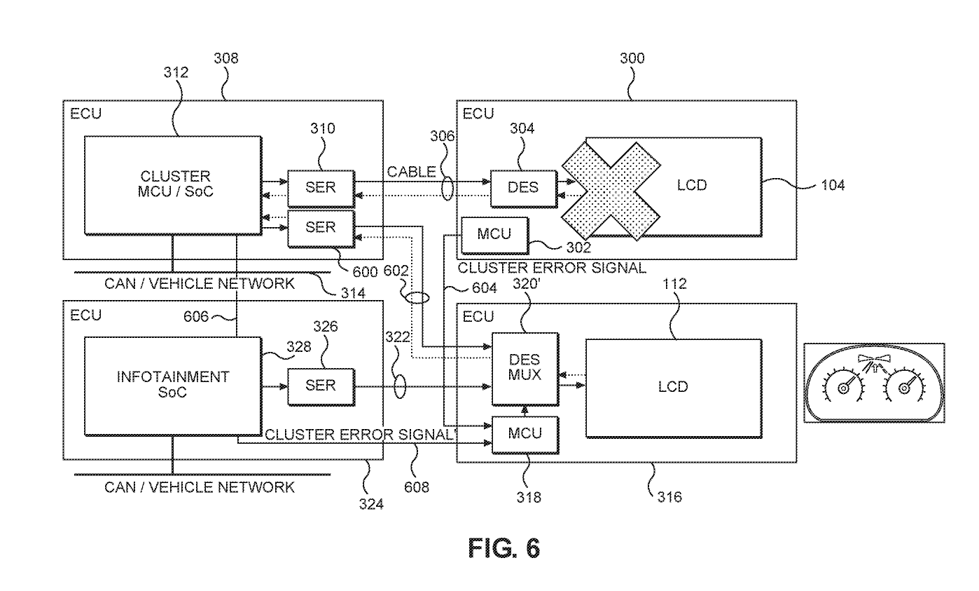

The presentation of the cluster data on the second display 112 is effectuated by providing or broadcasting the data that would be sent to the ECU 300 to the ECU 316 or an ECU controlling the secondary display. This broadcast may be done concurrently such that both the ECU 300 and the ECU 316 receive the data, or the initial data stream to the ECU 300 is terminated. Depending on the whether there is a single SoC controlling both displays (e.g., the cluster/infotainment SoC 410) or two SoCs controlling individual displays (e.g., the cluster SoC 312 and the infotainment SoC 328), there are different ways of sending the information to the ECU 316. FIGS. 6-9 illustrate a few exemplary ways.

In this regard, FIG. 6 illustrates a first exemplary aspect. On detection of a fault in the pixel data path (or communication path) to the instrument cluster display 104, the ECU 308 uses a second serializer/deserializer 600 to send information to a serializer/deserializer 320′. The serializer/deserializer 320′ is similar to the serializer/deserializer 320, but has two inputs and acts as a multiplexor that selects between the inputs to provide the display pixel data stream or other instructions to the second display 112. This may add a cable 602 to couple the serializer/deserializer 600 to the serializer/deserializer 320′. Further, the MCU 302 may send an error signal 604 to the MCU 318 so that the MCU 318 is alerted of the new data source. Likewise, the MCU 318 may send safety and/or CRC information to the ECU 308. The ECU 308 may also inform the ECU 324 of the change through a direct communication link 606 or over the vehicle network (e.g., the CAN 314). The infotainment SoC 328 may confirm the change to the MCU 318 with a cluster error signal' sent over a link 608.

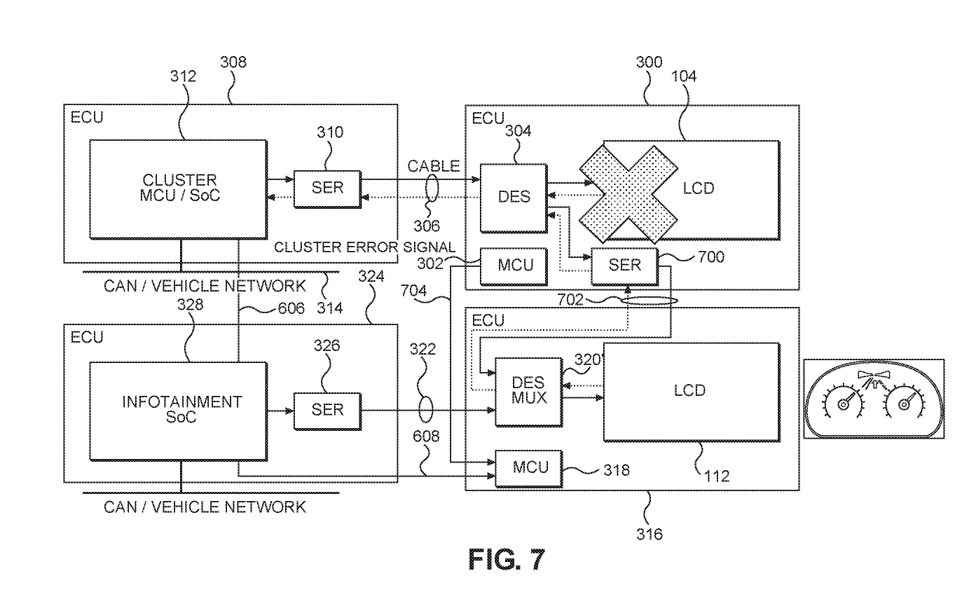

An alternate technique is to route the cluster data from the ECU 300 to the ECU 316 through a serializer/deserializer 700 and cable 702 as illustrated in FIG. 7. The MCU 302 may alert the MCU 318 that there is an error and that the change is forthcoming with a cluster error signal sent over a connection 704. Likewise, safety and/or CRC information may be sent from the ECU 316 to the ECU 300. Note that this aspect only works if the point of failure in the ECU 300 is in the instrument cluster display 104, because the cable 306, the serializer/deserializer 304 and the serializer/deserializer 310 still have to be operational for the ECU 300 to have the data to send to the ECU 316.

While not illustrated, another possibility would be to route the cluster error signal from the cluster SoC 312 to the infotainment SoC 328 and also send the cluster data from the cluster SoC 312 to the infotainment SoC 328, and allow the infotainment SoC 328 to send the cluster data to the ECU 316 through the cable 322. Such an arrangement may impose an additional burden on the vehicle network or require additional serializer/deserializers to allow the coupling between the cluster SoC 312 and the infotainment SoC 328.

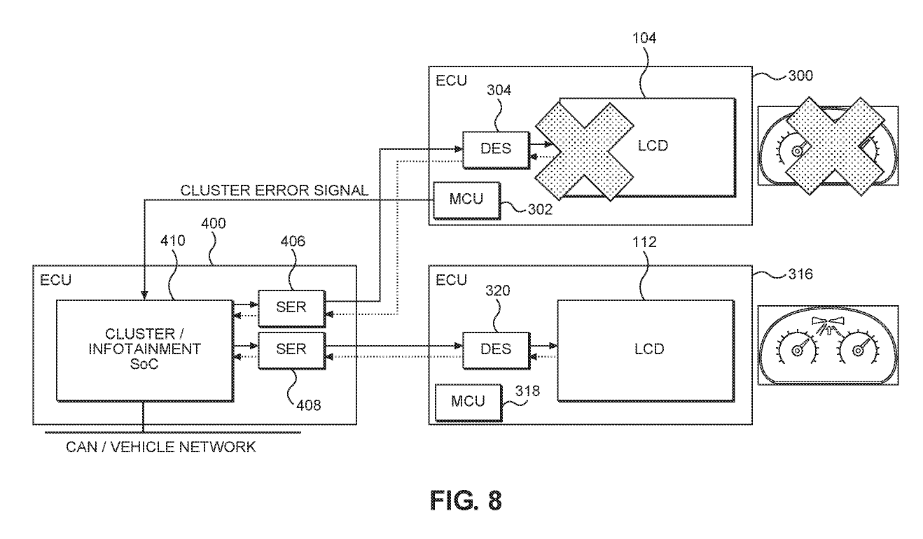

If there is a single SoC such as the cluster/infotainment SoC 410 that serves both the ECU 300 and the ECU 316, then the signaling is simplified as illustrated in FIG. 8. Once the heartbeat signal is lost or other cluster error signal is sent from the MCU 302 to the cluster/infotainment SoC 410, the cluster/infotainment SoC 410 uses the serializer/deserializer 408 to send data to the ECU 316 for the second display 112 to present the cluster data. Again, the ECU 316 may send safety or other CRC data back to the ECU 400.

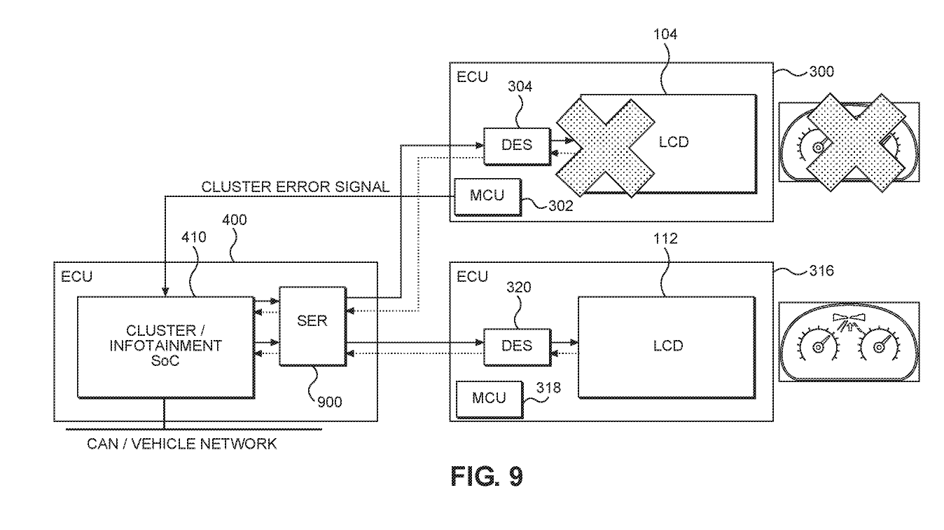

As another alternative, the ECU 400 may include a serializer 900 that is capable of providing two (or more) outputs and broadcasting the data from the single serializer 900 to both the ECU 300 and the ECU 316 as illustrated in FIG. 9. Once the heartbeat signal is lost or other cluster error signal is sent from the MCU 302 to the cluster/infotainment SoC 410, the cluster/infotainment SoC 410 uses the serializer 900 to send data to the ECU 316.

As alluded to above, while FIGS. 6-9 refer to a second display in the ECU 316, the present disclosure may send the data to any of the secondary displays and may send to multiple ones of the secondary displays.

Likewise, the present disclosure does not need to pre-empt completely the data otherwise being provided through the secondary display. There are various ways the telltale data may be added to the content being presented on the secondary display. Such display stacking techniques are explored in co-owned U.S. Provisional Patent Application Ser. No. 62/624,780, filed Jan. 31, 2018 and entitled “DRIVING MULTIPLE DISPLAYS WITH A SINGLE DISPLAY PORT,” which is hereby incorporated by reference in its entirety.

While the parent disclosure contemplated sending information to mobile terminals, there are myriad ways in which this data transfer may occur. Accordingly, the following discussion is provided to illustrate specific aspects. In particular, FIG. 10 illustrates a vehicle that communicates with a mobile terminal 1000 through a wireless connectivity module 1002 and antenna 1004. The wireless connectivity module 1002 may be a BLUETOOTH®, WIFI, 802.11ad compliant, wireless USB, or other relatively short-range module and may be distinct from the cluster SOC 312. While illustrated as being within the ECU 308, it is possible that the wireless connectivity module 1002 and antenna 1004 may be positioned external thereto, either in a separate ECU (not illustrated) or otherwise positioned.

The mobile terminal 1000 includes an antenna 1006, a wireless connectivity module 1008, an application processor 1010, and a display (also labeled LCD in FIG. 10) 1012. Note that the wireless connectivity module 1008 may be incorporated into the application processor 1010 (not shown). As described above, when there is a fault with the instrument cluster display 104, the signal may be provided to the second display 112 and/or the display 1012 of the mobile terminal 1000 through the wireless connectivity module 1002.

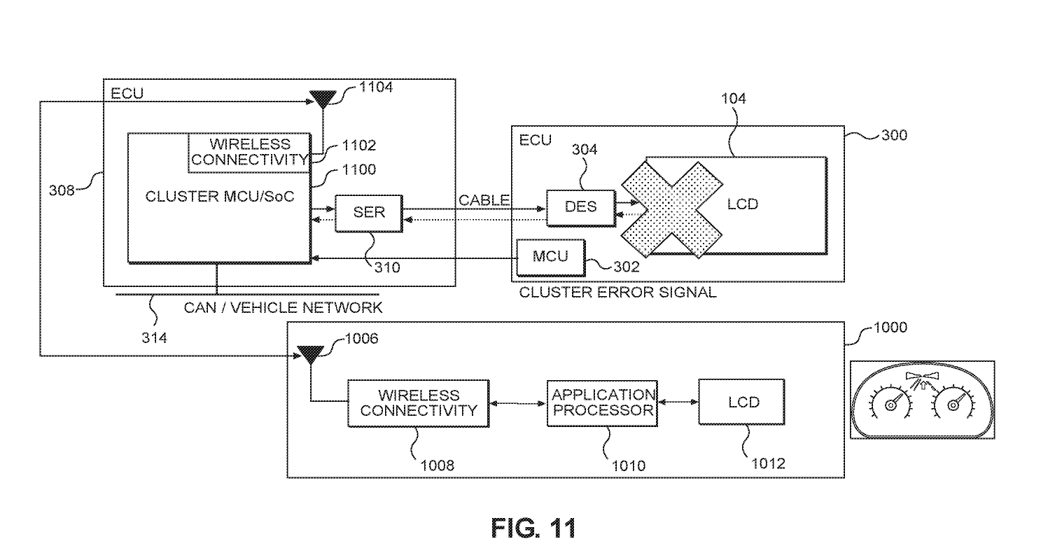

Similarly, the wireless connectivity module may be incorporated into the cluster SoC, as illustrated in FIG. 11. In this aspect, the ECU 308 may include a cluster SoC 1100 with a wireless connectivity module 1102 therein. The wireless connectivity module 1102 communicates with the mobile terminal 1000 through an antenna 1104, that may be in the ECU 308 or external thereto.

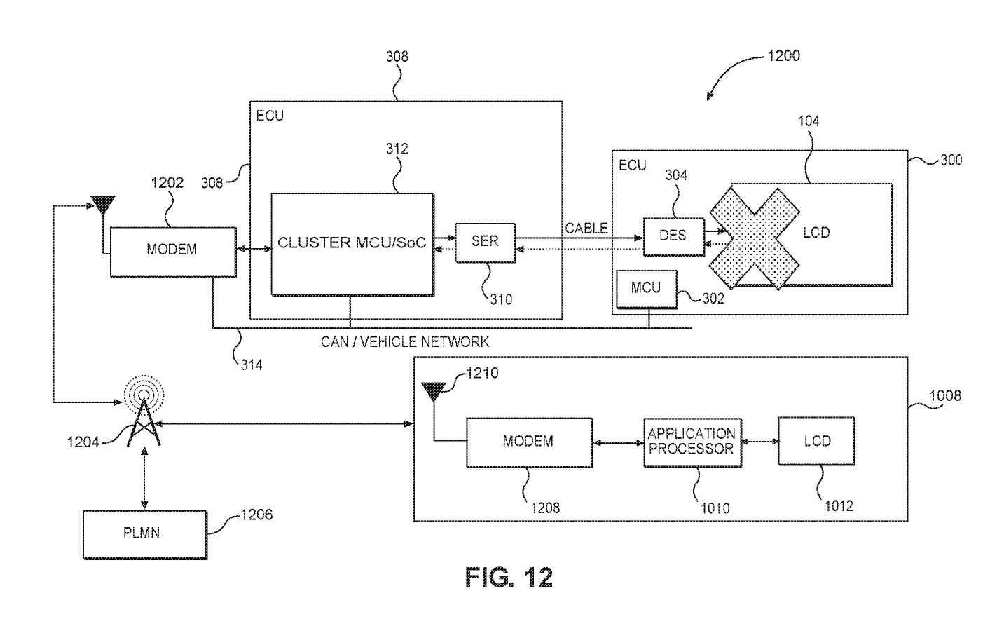

While the aspects described with reference to FIGS. 10 and 11 rely on a direct connection between the vehicle and the mobile terminal, the present disclosure is not so limited. For example, the vehicle may call a mobile terminal through a cellular network or the like as illustrated in FIG. 12. The vehicle 1200 includes a cellular modem 1202 or the like that is capable of communicating through a remote base station 1204 to a mobile network such as the Public Land Mobile Network (PLMN) 1206. The PLMN 1206 may operate according to any existing cellular or comparable protocol and create a data connection to the mobile terminal 1000 through the base station 1204 (or other base station (not shown)) and a modem 1208 within the mobile terminal 1000. The modem 1208 may use an antenna 1210 or may reuse an antenna such as the antenna 1006 (not shown in FIG. 12). The modem 1202 may be a modem that provides an internal phone/data connection for the vehicle 1200 and/or may be designated for use by another service such as ONSTAR, UCONNECT, or the like.

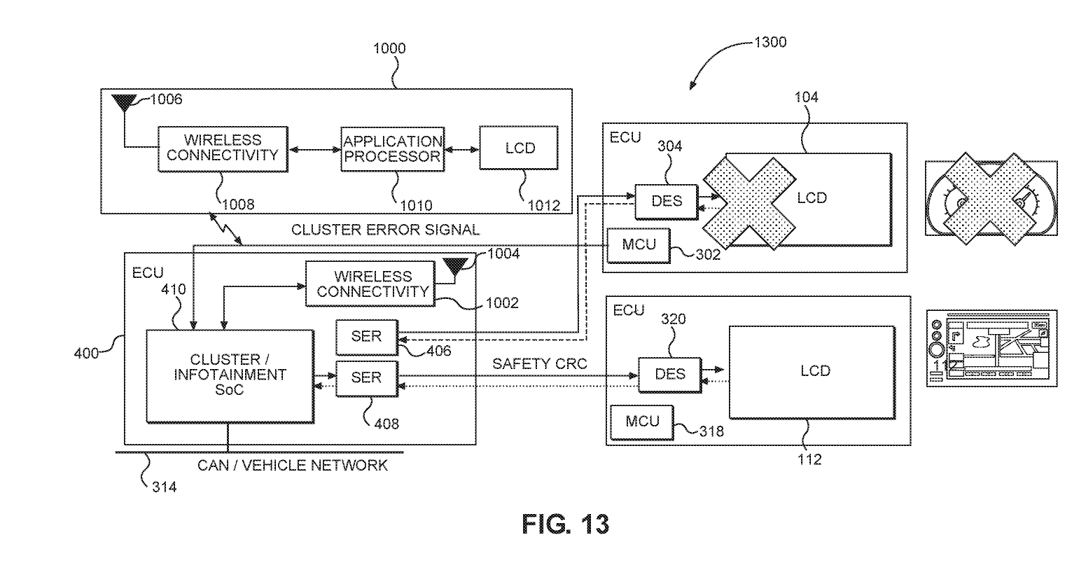

It should also be appreciated that aspects of the present disclosure also work where the cluster and infotainment displays are controlled by a single SoC such as illustrated in FIGS. 8 and 9. As with the system of FIG. 10, in FIG. 13, in a vehicle 1300, the wireless connectivity module 1002 may be distinct from the combined cluster/infotainment SoC 410. While illustrated within the ECU 400, the wireless connectivity module 1002 may be separate therefrom in its own ECU (not shown). In other regards, the vehicle 1300 is similar to the system of FIG. 10.

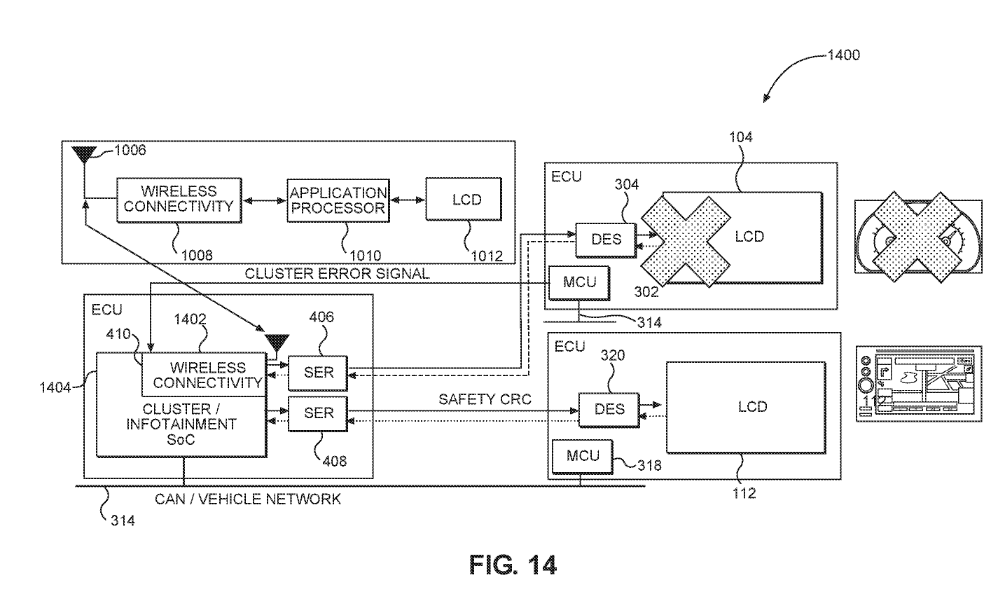

Likewise, as illustrated in FIG. 14, in a vehicle 1400, a wireless connectivity module 1402 may be incorporated into the combined cluster/infotainment SoC 1404. In other regards, the vehicle 1400 is similar to the vehicle of FIG. 11.

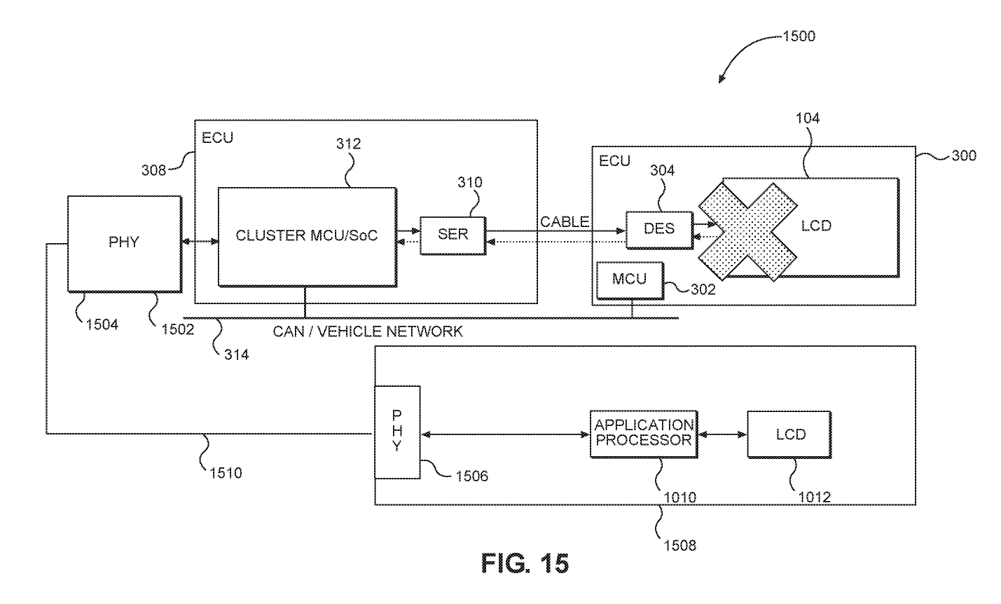

While wireless implementations are specifically contemplated, the present disclosure is not so limited. Some mobile terminals may be mobile computing devices with a display but lack a wireless connectivity module (e.g., certain ebook readers, some tablets, music players, navigation devices, or the like). These devices may still be coupled to a vehicle through a wired connection such as a USB cable, USB Type-C cable, LIGHTNING cable, DISPLAYPORT cable, or the like. FIG. 15 illustrates a vehicle 1500 that includes a wire-based outlet 1502 having a physical layer (PHY) 1504 that communicates with a PHY 1506 in a mobile terminal 1508 through a cable 1510. The PHY 1506 may communicate with the application processor 1010 to provide the video signal to the display 1012. Note that while illustrated as operating with a dedicated cluster MCU/SoC 312, this arrangement may also work for a combined cluster/infotainment SoC 410.

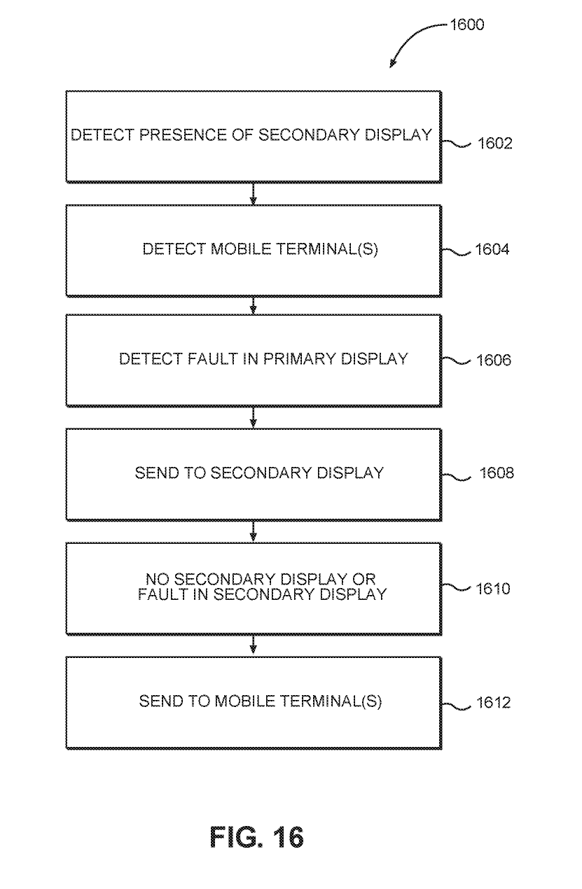

While there are myriad ways in which the telltales may be presented to a vehicle occupant and/or operator, there may be a hierarchy that dictates an order or preference for certain presentations. An exemplary process implementing such a hierarchy is provided in process 1600 illustrated in FIG. 16. In this regard, the process 1600 initially begins by the SoC (either the cluster MCU or the combined infotainment/cluster MCU) detecting the presence of one or more secondary displays (block 1602) (e.g., the second display 112). The SoC further detects the presence of one or more mobile terminals (block 1604). Normal operation proceeds until the SoC detects a fault in the primary display (block 1606). In an exemplary aspect, because greater control is provided over the second display 112, the telltale is sent to the second display 112 (block 1608), but if there is no second display 112 or a fault is detected in the second display 112 (block 1610), then the SoC may send the telltale to the mobile terminal(s) (block 1612).

In any of the aspects disclosed herein, the user may be alerted to the existence of a fault through an audible tone at fault detection, when the telltale is routed to a secondary display (e.g., a mobile terminal or the infotainment display), or the audible tone may be generated by the mobile terminal on receipt of the telltale to display.

In this regard, FIG. 17 is a system-level block diagram of an exemplary mobile terminal 1700 such as a smart phone, mobile computing device tablet, or the like. The mobile terminal 1700 includes an application processor 1704 (sometimes referred to as a host) that communicates with a mass storage element 1706 through a universal flash storage (UFS) bus 1708. The application processor 1704 may further be connected to a display 1710 through a display serial interface (DSI) bus 1712 and a camera 1714 through a camera serial interface (CSI) bus 1716. While DSI is specifically contemplated, other display connections with associated drivers could include DISPLAYPORT, HDMI, RGB, LVDS, and the like. Similarly, while CSI is specifically contemplated, other buses and protocols could be used. Various audio elements such as a microphone 1718, a speaker 1720, and an audio codec 1722 may be coupled to the application processor 1704 through a serial low-power interchip multimedia bus (SLIMbus) 1724. Additionally, the audio elements may communicate with each other through a SOUNDWIRE bus 1726. While SLIMbus and SOUNDWIRE are specifically contemplated, other buses such as I2S or the like could be used. A modem 1728 may also be coupled to the SLIMbus 1724 and/or the SOUNDWIRE bus 1726. The modem 1728 may further be connected to the application processor 1704 through a PCI or PCIE bus 1730 and/or a system power management interface (SPMI) bus 1732. While PCI/PCIE are contemplated, USB or other high-speed bus could also be used to communicate with the modem 1728.

With continued reference to FIG. 17, the SPMI bus 1732 may also be coupled to a local area network (LAN or WLAN) IC (LAN IC or WLAN IC) 1734, a power management integrated circuit (PMIC) 1736, a companion IC (sometimes referred to as a bridge chip) 1738, and a radio frequency IC (RFIC) 1740. It should be appreciated that separate PCI buses 1742 and 1744 may also couple the application processor 1704 to the companion IC 1738 and the WLAN IC 1734. The application processor 1704 may further be connected to sensors 1746 through a sensor bus 1748. The modem 1728 and the RFIC 1740 may communicate using a bus 1750.

With continued reference to FIG. 17, the RFIC 1740 may couple to one or more RFFE elements, such as an antenna tuner 1752, a switch 1754, and a power amplifier 1756 through a radio frequency front end (RFFE) bus 1758. Additionally, the RFIC 1740 may couple to an envelope tracking power supply (ETPS) 1760 through a bus 1762, and the ETPS 1760 may communicate with the power amplifier 1756. Collectively, the RFFE elements, including the RFIC 1740, may be considered an RFFE system 1764. It should be appreciated that the RFFE bus 1758 may be formed from a clock line and a data line (not illustrated).

Those of skill in the art will further appreciate that the various illustrative logical blocks, modules, circuits, and algorithms described in connection with the aspects disclosed herein may be implemented as electronic hardware, instructions stored in memory or in another computer readable medium and executed by a processor or other processing device, or combinations of both. The devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or any other such configuration).

The aspects disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, a hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein, but is to be accorded the widest scope consistent with the principles and novel features disclosed herein.

What is claimed is:

1. A method for controlling displays in a vehicle, comprising:
sending data from a first controller to a cluster display embedded control unit (ECU) of a vehicle for display on a cluster display within the cluster display ECU;
detecting a fault associated with the cluster display ECU of the vehicle or a communication path from the first controller to the cluster display ECU;
sending, from the first controller, cluster display information including at least one telltale to a secondary display on a mobile terminal in the vehicle.

2. The method of claim 1, wherein sending the cluster display information to the secondary display on the mobile terminal comprises sending to a secondary display on a device selected from the group consisting of: a cellular phone, a smartphone, a tablet, a phablet, a laptop computer, an entertainment unit, a navigation device, a communications device, a mobile location data unit, a global positioning system (GPS) device, a mobile phone, a portable computer, a mobile computing device, a wearable computing device, a personal digital assistant (PDA), a radio, a satellite radio, a music player, a digital music player, a portable music player, a digital video player, a video player, a digital video disc (DVD) player, a portable digital video player.

3. The method of claim 1, wherein sending the cluster display information to the secondary display comprises sending from a combined cluster/infotainment controller.

4. The method of claim 1, wherein sending the cluster display information comprises sending through a wireless connectivity module.

5. The method of claim 4, wherein sending the cluster display information through the wireless connectivity module comprises sending the cluster display information through a wireless connectivity module embedded in the first controller.

6. The method of claim 4, wherein sending the cluster display information through the wireless connectivity module comprises sending the cluster display information through a wireless connectivity module distinct from the first controller.

7. The method of claim 1, wherein sending the cluster display information comprises calling the mobile terminal with a vehicle modem.

8. The method of claim 3, wherein sending from the combined cluster/infotainment controller comprises sending through a wireless connectivity module.

9. The method of claim 8, wherein sending the cluster display information through the wireless connectivity module comprises sending the cluster display information through a wireless connectivity module embedded in the first controller.

10. The method of claim 8, wherein sending the cluster display information through the wireless connectivity module comprises sending the cluster display information through a wireless connectivity module distinct from the first controller.

11. The method of claim 4, wherein sending the cluster display information through the wireless connectivity module comprises sending the cluster display information through a module selected from the group consisting of: a BLUETOOTH module, a WIFI module, an 802.11ad compliant module, and a wireless Universal Serial Bus (USB) module.

12. The method of claim 1, further comprising generating an audible alert indicating the sending to the secondary display.

13. The method of claim 12, wherein generating the audible alert comprises generating an audible alert with the mobile terminal.

14. An embedded control unit (ECU) comprising:
a vehicle network interface configured to be coupled to a vehicle network;
a first cable interface configured to be coupled to a first cable;
a wireless connectivity module; and
a control system comprising a system on a chip (SoC), the control system configured to:
detect a fault in a cluster display ECU through the first cable; and
route cluster display information including a telltale to a mobile terminal through the wireless connectivity module.

15. The ECU of claim 14, wherein the wireless connectivity module comprises a module selected from the group consisting of: a wireless Universal Serial Bus (USB) module, a BLUETOOTH module, an 802.11ad compliant module, and a WIFI module.

16. The ECU of claim 14, wherein the control system comprises a combined cluster/infotainment controller.

17. The ECU of claim 16, wherein the wireless connectivity module is embedded into the combined cluster/infotainment controller.

18. The ECU of claim 16, wherein the wireless connectivity module is distinct from the combined cluster/infotainment controller.

19. The ECU of claim 14, wherein the control system comprises a cluster controller.

20. The ECU of claim 19, wherein the wireless connectivity module is embedded into the cluster controller.

21. The ECU of claim 19, wherein the wireless connectivity module is distinct from the cluster controller.

22. An embedded control unit (ECU) comprising:
a vehicle network interface configured to be coupled to a vehicle network;
a first cable interface configured to be coupled to a first cable;
a modem; and
a control system comprising a system on a chip (SoC), the control system configured to:
detect a fault in a cluster display ECU through the first cable; and
route cluster display information including a telltale to a mobile terminal through the modem.

23. An automobile comprising:
a cluster display embedded control unit (ECU) comprising:
a cluster display;
a cluster microcontroller unit (MCU); and
a first cable input configured to receive a first cable; and
a control system ECU comprising a control MCU configured to detect a fault in the cluster display ECU and route telltale information to a mobile terminal.

24. The automobile of claim 23, wherein the control MCU comprises a combined cluster/infotainment MCU.

25. The automobile of claim 23, wherein the control system ECU further comprises a wireless connectivity module.

26. The automobile of claim 25, wherein the wireless connectivity module is embedded in the control MCU.

27. The automobile of claim 25, wherein the wireless connectivity module is distinct from the control MCU.

28. The automobile of claim 23, further comprising a modem configured to call the mobile terminal through an external network.

29. The automobile of claim 23, wherein the control system is configured to generate an audible alert when routing the telltale information to the mobile terminal.
